(19) United States
(12) Patent Application Publication
(10) Pub. No.: US 2025/0282129 A1
(43) Pub. Date: Sep. 11, 2025

(54) METHOD OF MANUFACTURING BARRIER FILM FOR PACKAGING MATERIAL

(71) Applicant: FUJIFILM Corporation, Tokyo (JP)

(72) Inventors: Yoshihiko MOCHIZUKI, Minamiashigara-shi (JP); Eijiro IWASE, Minamiashigara-shi (JP)

(73) Assignee: FUJIFILM Corporation, Tokyo (JP)

(21) Appl. No.: 19/220,206

(22) Filed: May 28, 2025

Related U.S. Application Data
(63) Continuation of application No. PCT/JP2023/043790, filed on Dec. 7, 2023.

(30) Foreign Application Priority Data
Dec. 21, 2022 (JP) 2022-204170

(51) Int. Cl. B32B 37/12; B32B 7/12; B32B 27/08; B32B 27/32; B32B 37/18

(52) U.S. Cl. CPC B32B 37/1284; B32B 7/12; B32B 27/08; B32B 27/32; B32B 37/182; B32B 2307/72; B32B 2307/7244; B32B 2439/70

(57) ABSTRACT

Provided is a method of manufacturing a barrier film for a packaging material in which a decrease in gas barrier performance can be suppressed. Provided is a method of manufacturing a barrier film for a packaging material, the method including: a winding step of winding a gas barrier film including an underlying organic layer, an inorganic layer, and a protective organic layer in this order on a support in a roll shape; an adhesive layer application step of feeding the gas barrier film from the wound roll and applying an adhesive layer to the protective organic layer; and a sealant layer bonding step of bonding a sealant layer to the gas barrier film through the adhesive layer, in which the method further includes a pressure-sensitive adhesive film bonding step of bonding a pressure-sensitive adhesive film to the inorganic layer after forming the inorganic layer, and a pressure-sensitive adhesive film peeling step of peeling off the pressure-sensitive adhesive film before a protective organic layer application step of forming the protective organic layer, and in the protective organic layer application step, a difference between a charge voltage on a surface of the gas barrier film on the inorganic layer side and a charge voltage on a surface of the gas barrier film on the support side is 10 kV to 40 kV.

### CROSS-REFERENCE TO RELATED APPLICATIONS

This application is a Continuation of PCT International Application No. PCT/JP2023/043790 filed on Dec. 7, 2023, which claims priority under 35 U.S.C. § 119(a) to Japanese Patent Application No. 2022-204170 filed on Dec. 21, 2022. The above applications are hereby expressly incorporated by reference, in their entirety, into the present application.

### BACKGROUND OF THE INVENTION

### 1. Field of the Invention

The present invention relates to a method of manufacturing a barrier film for a packaging material.

### 2. Description of the Related Art

As a packaging material that packages chemical liquid, powdered drug, food, powder (for example, sugar) that is weak to moisture, or the like, a resin bag obtained by forming a resin film in a bag shape is used. For example, an infusion bag filled with an infusion solution including sugar, electrolyte liquid, amino acid, vitamin, and the like is known.

The resin film used as a material of a bag body in direct contact with chemical liquid in the packaging material forming the infusion bag has low gas barrier properties. The reason for this is to prevent additives for improving the gas barrier properties of the resin film from eluting into the infusion solution.

However, the chemical liquid such as sugar, amino acid, and electrolyte liquid filled in the infusion bag is likely to be significantly denatured by water and/or oxygen. Therefore, in a case where the bag body leaves to stand in the atmosphere, water and/or oxygen in the atmosphere may transmit through the infusion bag to denature the quality of the chemical liquid.

Accordingly, by bonding two gas barrier films having gas barrier properties to both surfaces of the bag body formed of the resin film or the like, respectively, to form an infusion bag, the gas barrier properties are ensured.

In addition, in the infusion bag, in order to check mixing of foreign matter in the drug or the like, discoloration of the drug, and the like, as at least one of the gas barrier films, a transparent barrier film having high gas barrier properties and high transparency and including an underlying organic layer, an inorganic layer, and a protective organic layer is used.

A sealant layer is bonded to the gas barrier film, and the gas barrier film is welded to the bag body through the sealant layer.

For example, JP2014-184627A describes a method of manufacturing a packaging material in which a laminated film where a sealant film is laminated on a barrier film is heated to melt the sealant film, the barrier film including a barrier laminate that includes a substrate film, at least one organic layer, and at least one inorganic layer.

This gas barrier film is prepared through so-called roll-to-roll (RtoR) of performing each of steps while transporting an elongated support. During the preparation of the gas barrier film through RtoR, in order to prevent the inorganic layer from being fractured, WO2018/043178A describes that, after forming an inorganic layer, a protective film is laminated on a surface of the inorganic layer before the formed inorganic layer comes into contact with another member, the protective film is peeled off from the inorganic layer before forming an intermediate organic layer, and an application step is performed before the inorganic layer comes into contact with another member.

### SUMMARY OF THE INVENTION

During the manufacturing of the gas barrier film, in a case where a protective organic layer is formed on the inorganic layer, while peeling the protective film from the inorganic layer and applying a coating liquid for forming the protective organic layer, attachment of foreign matter (dust) is unavoidable, which causes a problem. The present inventors conducted an investigation on this point and found the following points. Foreign matter attached to the surface on the inorganic layer side can be embedded in the protective organic layer by applying the coating liquid for forming the protective organic layer, and thus does not cause a problem. However, in a case where the film is wound around a backup roll of an application unit in a state where foreign matter is attached to the surface on the support side, unevenness occurs in the film, which causes a problem of a coating defect such as a non-uniform thickness of the protective organic layer. In addition, in a case where the protective organic layer is formed and wound in a roll shape in a state where foreign matter is attached to the surface on the support side, the surface on the support side comes into contact with the surface on the protective organic layer side. Therefore, the foreign matter is attached to the surface on the protective organic layer side. In a case where an adhesive for bonding the sealant layer is applied in a state where foreign matter is attached to the surface on the protective organic layer side, coating missing starts from the foreign matter, and adhesion with the sealant layer is insufficient, which causes a problem such as peel-off of the sealant layer.

As a result, gas barrier properties of a packaging material with the gas barrier film decrease, and there is a problem in that the content in the packaging material cannot be protected.

An object of the present invention is to solve the above-described problem of the related art and to provide a method of manufacturing a barrier film for a packaging material in which a decrease in gas barrier performance can be suppressed.

In order to achieve the object, the present invention has the following configurations.

[1] A method of manufacturing a barrier film for a packaging material, the method comprising:
a winding step of winding a gas barrier film including an underlying organic layer, an inorganic layer, and a protective organic layer in this order on a support in a roll shape;
an adhesive layer application step of feeding the gas barrier film from the wound roll and applying an adhesive layer to the protective organic layer; and
a sealant layer bonding step of bonding a sealant layer to the gas barrier film through the adhesive layer,
in which the method further includes
   a pressure-sensitive adhesive film bonding step of bonding a pressure-sensitive adhesive film to the inorganic layer after forming the inorganic layer, and
   a pressure-sensitive adhesive film peeling step of peeling off the pressure-sensitive adhesive film before a protective organic layer application step of forming the protective organic layer, and
in the protective organic layer application step, a difference between a charge voltage on a surface of the gas barrier film on the inorganic layer side and a charge voltage on a surface of the gas barrier film on the support side is 10 kV to 40 kV.

[2] The method of manufacturing a barrier film for a packaging material according to [1],
in which an adhesive strength at which the pressure-sensitive adhesive film is bonded to the inorganic layer is 0.01 to 0.5 N/25 mm, and
a peel strength at which the pressure-sensitive adhesive film is peeled off in the pressure-sensitive adhesive film peeling step is 5 to 30 N/25 mm.

[3] The method of manufacturing a barrier film for a packaging material according to [1] or [2],
in which another member does not come into contact with a surface of the inorganic layer opposite to the underlying organic layer in a period from an inorganic layer forming step of forming the inorganic layer on the underlying organic layer to the pressure-sensitive adhesive film bonding step.

[4] The method of manufacturing a barrier film for a packaging material according to any one of [1] to [3],
in which a material of the pressure-sensitive adhesive film is polyethylene or polypropylene.

[5] The method of manufacturing a barrier film for a packaging material according to any one of [1] to [4],
in which a water vapor transmission rate of the barrier film for a packaging material under conditions of a temperature of 25° C. and a relative humidity of 50% RH is 1.0×10⁻⁴ g/(m²·day) or less.

[6] The method of manufacturing a barrier film for a packaging material according to any one of [1] to [5],
in which a density of the inorganic layer is 2.0×10³ kg/m³ or more.

According to the present invention, it is possible to provide a method of manufacturing a barrier film for a packaging material in which a decrease in gas barrier performance can be suppressed.

### BRIEF DESCRIPTION OF THE DRAWINGS

FIG. 1 is a diagram conceptually showing an example of a barrier film for a packaging material that is prepared using a method of manufacturing a barrier film for a packaging material according to the present invention.

FIG. 2 is a conceptual diagram showing an example of the method of manufacturing a barrier film for a packaging material according to the present invention.

FIG. 3 is a conceptual diagram showing an example of the method of manufacturing a barrier film for a packaging material according to the present invention.

FIG. 4 is a diagram conceptually showing an example of a manufacturing device for performing a part of the method of manufacturing a barrier film for a packaging material according to the present invention.

FIG. 5 is a conceptual diagram showing an example of the method of manufacturing a barrier film for a packaging material according to the present invention.

FIG. 6 is a conceptual diagram showing an example of the method of manufacturing a barrier film for a packaging material according to the present invention.

FIG. 7 is a diagram conceptually showing an example of a packaging material with a gas barrier film including a barrier film for a packaging material according to the present invention.

### DESCRIPTION OF THE PREFERRED EMBODIMENTS

Hereinafter, a method of manufacturing a barrier film for a packaging material according to an embodiment of the present invention will be described in detail based on preferred examples shown in the accompanying drawings.

In the present invention, numerical ranges represented by “to” include numerical values before and after “to” as lower limit values and upper limit values.

### [Barrier Film for Packaging Material]

First, a configuration of a barrier film for a packaging material prepared using the method of manufacturing a barrier film for a packaging material according to the embodiment of the present invention will be described.

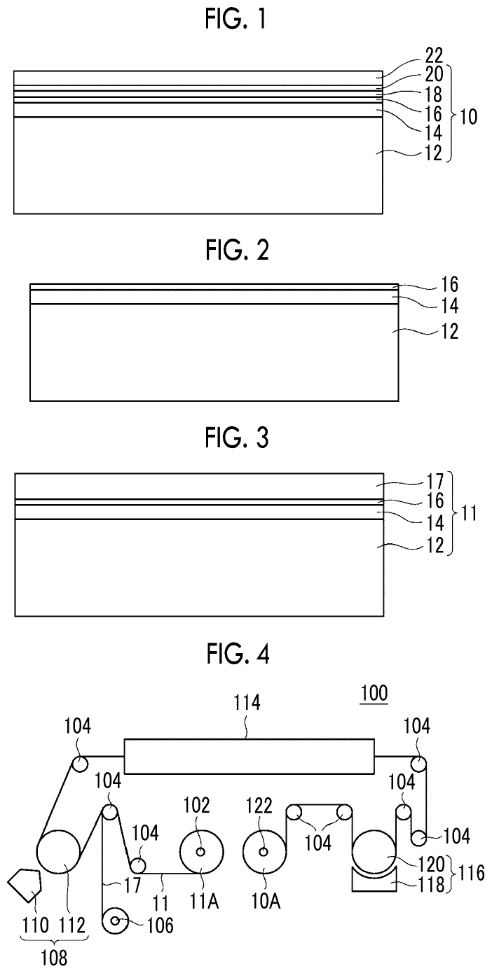

FIG. 1 is a diagram conceptually showing an example of a barrier film for a packaging material that is prepared using the method of manufacturing a barrier film for a packaging material according to the embodiment of the present invention. FIG. 1 is a conceptual diagram where the gas barrier film is seen from a plane direction of a main surface (direction parallel to the main surface). The main surface is the maximum surface of a sheet-shaped material (a film or a plate-shaped material).

The barrier film for a packaging material shown in FIG. 1 includes: a gas barrier film 10 that includes a support 12, an underlying organic layer 14, an inorganic layer 16, and a protective organic layer 18 in this order; and a sealant layer (thermal fusion layer) 22 that is bonded to the protective organic layer 18 side of the gas barrier film 10 through an adhesive layer 20.

In the following description, the support 12 side of the barrier film for a packaging material will also be referred to as “lower side”, and the sealant layer 22 side thereof will also be referred to as “upper side”. The same also applies to FIGS. 2 to 3 and 5 and 6 described below.

The gas barrier film 10 includes the support 12, the inorganic layer 16 that mainly exhibits gas barrier performance, the underlying organic layer 14 that functions as an underlying layer of the inorganic layer 16, and the protective organic layer 18 that functions as a protective layer for protecting the inorganic layer 16.

In the example shown in FIG. 1, the gas barrier film 10 includes one combination of the underlying organic layer 14 and the inorganic layer 16 but is not limited thereto. The gas barrier film 10 may include two or more combinations of the underlying organic layers 14 and the inorganic layers 16. That is, for example, the gas barrier film may have a configuration where the support 12, the underlying organic layer 14, the inorganic layer 16, the underlying organic layer 14, the inorganic layer 16, and the protective organic layer 18 are laminated in this order.

### <Support>

As the support 12, a well-known sheet-shaped material (a film or a plate-shaped material) that is used as a support for various gas barrier films, various laminated functional films, and the like can be used.

A material of the support 12 is not particularly limited, and various materials can be used as long as the underlying organic layer 14 and the inorganic layer 16 can be formed. As the material of the support 12, a material having high transparency is preferable and, for example, various resin materials can be used.

Examples of the material of the support 12 include polyethylene (PE), polyethylene naphthalate (PEN), polyamide (PA), polyethylene terephthalate (PET), polyvinyl chloride (PVC), polyvinyl alcohol (PVA), polyacrylonitrile (PAN), polyimide (PI), transparent polyimide, polymethyl methacrylate resin (PMMA), polycarbonate (PC), polyacrylate, polymethacrylate, polypropylene (PP), polystyrene (PS), an acrylonitrile-butadiene-styrene copolymer (ABS), a cycloolefin copolymer (COC), a cycloolefin polymer (COP), triacetyl cellulose (TAC), and an ethylene-vinyl alcohol copolymer (EVOH).

The thickness of the support 12 can be appropriately set depending on the use, the material, and the like.

The thickness of the support 12 is not limited, but is preferably 5 to 150 μm and more preferably 10 to 100 μm from the viewpoints that, for example, the mechanical strength of the gas barrier film 10 can be sufficiently ensured, a gas barrier film having good flexibility can be obtained, the weight and thickness of the gas barrier film 10 can be reduced.

### <Underlying Organic Layer>

In the gas barrier film 10, the underlying organic layer 14 is formed on one surface of the support 12.

The underlying organic layer 14 consists of, for example, an organic compound obtained by polymerization (crosslinking or curing) of a monomer, a dimer, an oligomer, or the like.

The underlying organic layer 14 functioning as the underlayer of the inorganic layer 16 is an underlayer for appropriately forming the inorganic layer 16.

The underlying organic layer 14 formed on the surface of the support 12 embeds unevenness of the surface of the support 12, foreign matter attached to the surface, and the like to appropriately planarize the formation surface of the inorganic layer 16 such that the inorganic layer 16 can be appropriately formed.

In the present invention, the gas barrier film may include plural sets of combinations of the inorganic layers 16 and the underlying organic layers 14. In this case, the second or subsequent underlying organic layer 14 is formed on the inorganic layer 16. Even in this configuration, the underlying organic layer 14 functioning as the underlayer (the formation surface of the inorganic layer 16) of the inorganic layer 16 exhibits the same action.

In particular, by providing the underlying organic layer 14 on the surface of the support 12, the inorganic layer 16 that mainly exhibits gas barrier properties can be appropriately formed.

The underlying organic layer 14 is formed, for example, by curing a composition for forming an organic layer, that includes an organic compound (a monomer, a dimer, a trimer, an oligomer, a polymer, and the like). The composition for forming an organic layer may include one kind or two or more kinds of organic compounds.

The underlying organic layer 14 includes, for example, a thermoplastic resin and an organic silicon compound. Examples of the thermoplastic resin include polyester, a (meth) acrylic resin, a methacrylic acid-maleic acid copolymer, polystyrene, a transparent fluororesin, polyimide, fluorinated polyimide, polyamide, polyamide imide, polyether imide, cellulose acylate, polyurethane, polyether ether ketone, polycarbonate, an alicyclic polyolefin, polyarylate, polyethersulfone, polysulfone, fluorene ring-modified polycarbonate, alicyclic-modified polycarbonate, fluorene ring-modified polyester, and an acrylic compound. Examples of the organic silicon compound include polysiloxane.

From the viewpoints of high strength and glass transition temperature, it is preferable that the underlying organic layer 14 includes a polymer of a radically curable compound and/or a cationically curable compound having an ether group.

From the viewpoint of reducing the refractive index of the underlying organic layer 14, it is preferable that the underlying organic layer 14 includes a (meth)acrylic resin including, as a major component, a polymer of a monomer, an oligomer, or the like of (meth)acrylate. By reducing the refractive index of the underlying organic layer 14, transparency increases, and a light-transmitting property is improved.

It is more preferable that the underlying organic layer 14 includes a (meth) acrylic resin including, as a major component, a monomer, a dimer, an oligomer, or the like of a bi-or higher functional (meth)acrylate such as dipropylene glycol di(meth)acrylate (DPGDA), trimethylolpropane tri(meth)acrylate (TMPTA), or dipentaerythritol hexa(meth)acrylate (DPHA), and it is still more preferable that the underlying organic layer 14 includes a (meth)acrylic resin including, as a major component, a polymer of a monomer or a polymer such as a dimer, an oligomer of a tri-or higher functional (meth) acrylate. In addition, a plurality of (meth)acrylic resins may be used. The major component refers to a component having the highest content mass ratio among components included.

It is preferable that the composition for forming an organic layer includes an organic solvent, a surfactant, and a silane coupling agent in addition to the organic compound.

In a case where a plurality of underlying organic layers 14 are provided, that is, in a case where plural sets of combinations of the underlying organic layers 14 and the inorganic layers 16 are provided, the materials of the underlying organic layers 14 may be the same as or different from each other.

The thickness of the underlying organic layer 14 is not limited and can be appropriately set according to components in the composition for forming an organic layer, the support 12 used, and the like.

The thickness of the underlying organic layer 14 is preferably 0.1 to 5 μm and more preferably 0.2 to 3 μm. It is preferable that the thickness of the underlying organic layer 14 is 0.1 μm or more from the viewpoint of embedding unevenness of the surface of the support 12, foreign matter attached to the surface, and the like such that the surface of the underlying organic layer 14 can be planarized. It is preferable that the thickness of the underlying organic layer 14 is 5 μm or less from the viewpoints that, for example, cracks of the underlying organic layer 14 can be prevented, the flexibility of the gas barrier film 10 can be improved, and the thickness and weight of the gas barrier film 10 can be reduced.

In a case where a plurality of underlying organic layers 14 are provided, that is, a case where plural sets of combinations of the inorganic layers 16 and the underlying organic layers 14 are provided, the thicknesses of the respective underlying organic layers 14 may be the same as or different from each other.

The underlying organic layer 14 can be formed with a well-known method depending on materials.

For example, the underlying organic layer 14 can be formed with a coating method of applying the above-described composition for forming an organic layer and drying the composition for forming an organic layer. During the formation of the underlying organic layer 14 with the coating method, the dried composition for forming an organic layer is irradiated with ultraviolet rays to polymerize (crosslink) the organic compound in the composition for forming an organic layer.

The underlying organic layer 14 is formed through roll-to-roll (RtoR) of applying and drying the composition for forming an organic layer while transporting a support.

### <Inorganic Layer>

The inorganic layer 16 is a thin film including an inorganic compound, and is provided on a surface of the underlying organic layer 14 or a surface of the support 12. In the gas barrier film 10, the inorganic layer 16 mainly exhibits gas barrier properties.

The surface of the support 12 includes a region such as unevenness or shadow of foreign matter to which the inorganic compound is not likely to adhere. By providing the underlying organic layer 14 and forming the inorganic layer 16 thereon, the region to which the inorganic compound is not likely to adhere is covered. Therefore, the inorganic layer 16 can be formed on the formation surface of the inorganic layer 16 without a gap.

A material of the inorganic layer 16 is not particularly limited, and various inorganic compounds that are used for a well-known gas barrier layer consisting of an inorganic compound exhibiting gas barrier properties can be used.

Examples of a material of the inorganic layer 16 include inorganic compounds, for example, a metal oxide such as aluminum oxide, magnesium oxide, tantalum oxide, zirconium oxide, titanium oxide, or indium tin oxide (ITO); a metal nitride such as aluminum nitride; a metal carbide such as aluminum carbide; a silicon oxide such as silicon oxide, silicon oxynitride, silicon oxycarbide, or silicon oxynitride-carbide; a silicon nitride such as silicon nitride or silicon nitride-carbide; a silicon carbide such as silicon carbide; a hydride thereof; a mixture of two or more kinds thereof; and a hydrogen-containing material thereof. In addition, a mixture of two or more kinds of the examples can be used.

In particular, silicon nitride, silicon oxide, silicon oxynitride, aluminum oxide, or a mixture of two or more kinds thereof is preferably used from the viewpoints that transparency is high and excellent gas barrier properties can be exhibited. In particular, a compound including silicon is preferably used, and silicon nitride is more preferably used from the viewpoint that excellent gas barrier properties can be exhibited.

The thickness of the inorganic layer 16 is not particularly limited and can be appropriately set depending on materials such that desired gas barrier properties can be exhibited.

The thickness of the inorganic layer 16 is preferably 10 to 150 nm, more preferably 12 to 100 nm, and still more preferably 15 to 75 nm.

It is preferable that the thickness of the inorganic layer 16 is 10 nm or more from the viewpoint that the inorganic layer 16 stably exhibiting sufficient gas barrier performance can be formed. In addition, in a case where the inorganic layer 16 is generally brittle and is excessively thick, breakage, cracking, peeling, or the like may occur. However, by adjusting the thickness of the inorganic layer 16 to be 150 nm or less, the occurrence of breakage can be suppressed.

In a case where a plurality of inorganic layers 16 are provided, the thicknesses of the inorganic layers 16 may be the same as or different from each other.

In addition, in a case where a plurality of inorganic layers 16 are provided, the materials of the inorganic layers 16 may be the same as or different from each other.

The inorganic layer 16 can be formed with a well-known method depending on materials.

For example, plasma CVD such as capacitively coupled plasma (CCP)-chemical vapor deposition (CVD) or inductively coupled plasma (ICP)-CVD, atomic layer deposition (ALD), sputtering such as magnetron sputtering or reactive sputtering, or various vapor deposition methods such as vacuum deposition can be suitably used.

In addition, the inorganic layer 16 is also formed through roll-to-roll.

### <Protective Organic Layer>

The protective organic layer 18 is a layer for protecting the inorganic layer 16, the layer consisting of an organic material. By providing the protective organic layer 18, breakage or the like of the inorganic layer 16 can be prevented.

A material for forming the protective organic layer 18 is not particularly limited, and various well-known organic compounds can be used as in the underlying organic layer 14.

In addition, as the material for forming the protective organic layer 18, a urethane skeleton acrylate polymer such as a polymerizable composition for forming a second organic layer described in paragraphs “0016” to “0027” of JP2015-171798A may be used. In addition, the composition for forming the protective organic layer 18 may include an additive such as a monomer, an oligomer, or a polymer, a polymerization initiator, and a silane coupling agent, in addition to the urethane skeleton acrylate polymer.

The thickness of the protective organic layer 18 may be appropriately set depending on the material for forming the protective organic layer 18, the material for forming the inorganic layer 16, the thickness of the inorganic layer 16, and the like. According to an investigation by the present inventors, the thickness of the protective organic layer 18 is preferably 0.1 to 50 μm, more preferably 0.5 to 25 μm, and still more preferably 1 to 10 μm. By adjusting the thickness of the protective organic layer 18 to be 0.1 μm or more, the inorganic layer 16 can be appropriately protected. In addition, by adjusting the thickness of the protective organic layer 18 to be 50 μm or less, the thickness of the gas barrier film 10 can be reduced.

Here, in a case where a gas barrier film including plural sets of combinations of the underlying organic layers 14 and the inorganic layers 16 is prepared, the formation of the underlying organic layer 14 and the formation of the inorganic layer 16 may be repeated according to the number of the combinations of the underlying organic layers 14 and the inorganic layers 16. In this case, in a case where the underlying organic layer 14 is formed on the inorganic layer 16, it is preferable that, in a state where a protective film is laminated to protect the inorganic layer 16 after forming the inorganic layer 16, the laminate is transported to a device for forming the underlying organic layer 14 and the protective film is peeled off immediately before forming the underlying organic layer 14.

In addition, in the present invention, it is preferable that the gas barrier film has high gas barrier performance. Specifically, a water vapor transmission rate of the gas barrier film under conditions of a temperature of 25° C. and a relative humidity of 50% RH is preferably 1.0×10⁻³ g/(m²·day) or less, more preferably 4×10⁻⁴ g/(m²·day) or less, and still more preferably 1×10⁻⁴ g/(m²·day) or less.

In addition, from the viewpoint of obtaining high gas barrier performance, a density of the inorganic layer of the gas barrier film is preferably 2.0×10³ kg/m³ or more, more preferably 2.05×10³ kg/m³ or more, and more preferably 2.1×10³ kg/m³ or more.

### <Sealant Layer>

The sealant layer 22 is a layer for bonding the gas barrier film 10 to an object by heat sealing (thermal welding (thermal fusion)).

Basically, the sealant layer is formed of the same forming material as the object to which the gas barrier film is heat-sealed. For example, in a case where the object is an infusion bag, the sealant layer is formed of the same material as the material for forming the infusion bag. That is, in a case where the object to be heat-sealed is formed of polyethylene (PE), a sheet-shaped material (film-shaped material) formed of PE may be used as the sealant layer 22, and in a case where the object to be heat-sealed is formed of polypropylene (PP), a sheet-shaped material (film-shaped material) formed of PP may be used as the sealant layer 22.

Specifically, as the material for forming the sealant layer 22, a resin film described in paragraph of JP2012-075716A can be used.

In addition, the thickness of the sealant layer is not also limited, and may be appropriately selected depending on the material for forming the sealant layer and the shape, state, or the like of the object such as an infusion bag to be heat-sealed such that the object can be reliably thermally welded. Here, according to the study by the inventors of the present invention, the thickness of the sealant layer is preferably 5 to 150 μm, more preferably 10 to 100 μm, and still more preferably 30 to 70 μm. The thickness of the sealant layer is preferably 5 μm or more from the viewpoints that, for example, more reliable heat sealing can be performed and unevenness of a surface of the object to be heat-sealed can be suitably absorbed. The thickness of the sealant layer is preferably 150 μm or less from the viewpoints that, for example, the thickness of the gas barrier film can be reduced and permeation of water vapor and/or oxygen from a side surface of the sealant layer during thermal welding of the infusion bag or the like can be more effectively suppressed.

### <Adhesive Layer>

The adhesive layer 20 is a layer for bonding the sealant layer 22 and the surface of the gas barrier film 10 on the protective organic layer 18 side.

As the adhesive layer 20, all of well-known adhesives through which the sealant layer 22 can adhere to the protective organic layer 18 can be used.

In addition, the thickness of the adhesive layer 20 is not limited, and may be appropriately selected such that the sealant layer 22 can reliably adhere to the protective organic layer 18.

### [Method of Manufacturing Barrier Film for Packaging Material]

The method of manufacturing a barrier film for a packaging material according to the embodiment of the present invention comprises:
a winding step of winding a gas barrier film including an underlying organic layer, an inorganic layer, and a protective organic layer in this order on a support in a roll shape;
an adhesive layer application step of feeding the gas barrier film from the wound roll and applying an adhesive layer to the protective organic layer; and
a sealant layer bonding step of bonding a sealant layer to the gas barrier film through the adhesive layer,
in which the method further includes
   a pressure-sensitive adhesive e film bonding step of bonding pressure-sensitive adhesive film to the inorganic layer after forming the inorganic layer, and
   a pressure-sensitive adhesive film peeling step of peeling off the pressure-sensitive adhesive film before a protective organic layer application step of forming the protective organic layer, and
in the protective organic layer application step, a difference between a charge voltage on a surface of the gas barrier film on the inorganic layer side and a charge voltage on a surface of the gas barrier film on the support side is 10 kV to 40 kV.

The method of manufacturing a barrier film for a packaging material according to the embodiment of the present invention (hereinafter, also referred to as the manufacturing method according to the embodiment of the present invention) will be described in order.

In the manufacturing method according to the embodiment of the present invention, basically, by using an elongated support and repeating a step of forming each of the layers and a winding step while transporting the support, the barrier film for a packaging material including the support 12, the underlying organic layer 14, the inorganic layer 16, the protective organic layer 18, the adhesive layer 20, and the sealant layer 22 is prepared. That is, in the manufacturing method according to the embodiment of the present invention, a step of forming the underlying organic layer 14, a step of forming the inorganic layer 16, a step of forming the protective organic layer 18, a step of forming the adhesive layer 20, and a step of forming the sealant layer 22 are performed in this order.

In this case, the respective steps may be continuously performed while transporting the elongated support, but the layers need to be formed using different manufacturing devices. Therefore, after a step of forming one layer, the laminate is temporarily wound in a roll shape, this roll is set in a manufacturing device for forming the next layer, and the film is fed from the roll to form the next layer.

In particular, the inorganic layer 16 needs to be formed using a forming method, such as the above-described plasma CVD, that is performed in a vacuum. Therefore, it is difficult to continuously perform the formation of the inorganic layer 16 and the formation of the underlying organic layer 14 and the protective organic layer 18 that are formed before and after the inorganic layer 16. Accordingly, after the step of forming the underlying organic layer 14, the laminate is temporarily wound, this roll is subjected to the step of forming the inorganic layer 16. In addition, after the step of forming the inorganic layer 16, the laminate is wound, and this roll is subjected to the step of forming the protective organic layer 18.

Here, the inorganic layer 16 is a layer that mainly exhibits gas barrier performance but is likely to be broken. Therefore, after the step of forming the inorganic layer 16, a protective film (pressure-sensitive adhesive film) is bonded to the inorganic layer 16 before winding the laminate in a roll shape such that the inorganic layer 16 is prevented from being fractured.

That is, the manufacturing method according to the embodiment of the present invention further comprises: a pressure-sensitive adhesive film bonding step of bonding a pressure-sensitive adhesive film to the inorganic layer 16 after forming the inorganic layer 16; and a pressure-sensitive adhesive film peeling step of peeling off the pressure-sensitive adhesive film before a protective organic layer application step of forming the protective organic layer 18.

In the manufacturing method according to the embodiment of the present invention, in the protective organic layer application step, a difference in charge voltage of a surface of the gas barrier film on the inorganic layer 16 side from a surface of the gas barrier film on the support 12 side is 10 kV to 40 kV.

Hereinafter, each of the steps in the manufacturing method according to the embodiment of the present invention will be described.

The steps of forming the underlying organic layer 14 and the inorganic layer 16 are as described above. The laminate passed through the steps of forming the underlying organic layer 14 and the inorganic layer 16 includes the support 12, the underlying organic layer 14, and the inorganic layer 16 in this order as shown in FIG. 2.

After forming the inorganic layer 16, a pressure-sensitive adhesive film bonding step of bonding a pressure-sensitive adhesive film (protective film) 17 to the inorganic layer 16 is performed before winding the laminate shown in FIG. 2 in a roll shape such that a laminate 11 shown in FIG. 3 is formed.

As a method of bonding the pressure-sensitive adhesive film, a well-known method in the related art, for example, a method laminating and bonding the pressure-sensitive adhesive film 17 drawn from the film roll on the surface of the inorganic layer 16 in a laminating roller after forming the inorganic layer 16 can be used.

It is preferable that another member does not come into contact with a surface of the inorganic layer 16 opposite to the underlying organic layer 14 in a period from an inorganic layer forming step of forming the inorganic layer 16 on the underlying organic layer 14 to the pressure-sensitive adhesive film bonding step. That is, it is preferable that, after forming the inorganic layer 16, the pressure-sensitive adhesive film 17 is bonded before a transport roller comes into contact with the surface on the inorganic layer 16 side. As a result, fracture of the inorganic layer 16 caused by contact with another member can be prevented.

As the pressure-sensitive adhesive film 17, various well-known sheet-shaped materials that can be used as a protective film in the manufacturing of a gas barrier film can be used. From the viewpoints that, for example, the film can be bonded while being stretched with tension due to low stiffness such that wrinkles are not likely to occur, unintended tension is not applied to the support due to low stiffness such that there is not likely to be a problem during transport, and the cost is low, it is preferable that a film consisting of polyethylene or polypropylene is used as the pressure-sensitive adhesive film 17.

The thickness of the pressure-sensitive adhesive film is not particularly limited as long as it is a thickness in which breakage or the like of the layer (inorganic layer 16) to be protected can be prevented. The thickness of the pressure-sensitive adhesive film is preferably 20 μm or more. In addition, from the viewpoints of the flexibility of the gas barrier film, a reduction in size and weight, easiness of winding in a roll shape, the thickness of the adhesive film is preferably 100 μm or less.

The laminate 11 where the pressure-sensitive adhesive film 17 is bonded is wound in a roll shape to obtain a laminate roll 11A, and the laminate roll 11A is subjected to a manufacturing device for performing the step of forming the protective organic layer 18.

FIG. 4 is a diagram conceptually showing an example of the manufacturing device for performing the step of forming the protective organic layer 18.

An organic film forming device 100 shown in FIG. 4 is a coating film forming device for forming the protective organic layer 18. The organic film forming device 100 forms the protective organic layer 18 through RtoR, in which while transporting the elongated laminate 11 in a longitudinal direction, a coating liquid for forming the protective organic layer 18 is applied, dried, and irradiated with ultraviolet rays (UV) to form the protective organic layer 18.

The organic film forming device 100 in the example shown in the drawing includes, for example, a rotating shaft 102, a plurality of transport rollers 104, a winding shaft 106, an application unit 108, a drying unit 114, a curing unit 116, and a winding shaft 122.

The rotating shaft 102 is a rotating shaft in which the laminate roll 11A obtained by winding the elongated laminate 11 is charged. The laminate 11 is drawn from the laminate roll 11A charged in the rotating shaft 102.

The laminate 11 drawn from the laminate roll 11A passes through the application unit 108, the drying unit 114, and the curing unit 116 and reaches the winding shaft 122, that is, passes through a predetermined transport path. The transport roller 104 supports the laminate 11 that is transported, and the plurality of transport rollers 104 are disposed to define the predetermined transport path.

The winding shaft 106 is disposed upstream of the application unit 108, and winds the pressure-sensitive adhesive film 17 peeled in the pressure-sensitive adhesive film peeling step. In the example shown in the drawing, in a preferable aspect, the pressure-sensitive adhesive film 17 is peeled off at a position of the transport rollers 104 immediately before the application unit 108 (immediately upstream of the application unit on the transport path). That is, in the organic film forming device 100, the pressure-sensitive adhesive film peeling step is performed at the position of the transport rollers 104 immediately before the application unit 108.

The application unit 108 is a unit that performs the protective organic layer application step of applying the coating liquid for forming the protective organic layer 18 to the surface of the inorganic layer 16 that is exposed after the pressure-sensitive adhesive film 17 is peeled off. In the example shown in the drawing, the application unit 108 includes a backup roll 112 and a die coater 110. The application unit 108 winds the laminate including the support 12, the underlying organic layer 14, and the inorganic layer 16 after peeling off the pressure-sensitive adhesive film 17 around the backup roller 112, and applies the coating liquid for forming the protective organic layer 18 to the surface of the inorganic layer 16 using the die coater 110 at the position where the laminate is wound around the backup roller 112.

As shown in FIG. 4, the application unit 108 winds the laminate around the backup roll 112 and performs the application. As a result, during the application, the laminate can be prevented from rattling, and the coating thickness can be prevented from varying.

In the example shown in the drawing, the application unit 108 applies the coating liquid for forming the underlying organic layer using the die coater 110, the present invention is not limited thereto. As the method of applying the coating liquid for forming the underlying organic layer in the application unit 108, various well-known methods such as a die coating method, a dip coating method, an air knife coating method, a curtain coating method, a roller coating method, a wire bar coating method, and a gravure coating method can be used. From the viewpoint that it is preferable to perform the application in a contactless manner to prevent fracture of the inorganic layer 16, the application method in the application unit 108 is preferably a die coating method.

In addition, during the application in the application unit 108, as shown in FIG. 4, it is preferable that the laminate is transported such that the coating surface (surface on the inorganic layer 16 side) faces downward in the vertical direction, the laminate vertically rises in the application unit, and the laminate is transported such that the coating surface faces upward after the application. In addition, it is preferable that, in the transport path from the position where the pressure-sensitive adhesive film 17 is peeled off to the application unit 108, the laminate is transported such that the coating surface (surface on the inorganic layer 16 side) faces downward in the vertical direction.

The laminate to which the coating liquid for forming the protective organic layer 18 is applied in the application unit 108 is transported to the drying unit 114. The drying unit 114 is a unit that performs a drying step of drying the layer of the applied coating liquid.

For example, the drying unit 114 may include a heating device for heating and drying the laminate from the front surface side (the side of the layer of the coating liquid for forming the protective organic layer 18) and a heating device for heating and drying the laminate from the back surface side of the support 12 such that the layer of the coating liquid is dried from both of the front surface side and the back surface side.

Heating in the drying unit 114 may be performed using a well-known method for heating a sheet-shaped material. For example, the drying on the front surface side may be performed by hot air drying, and the drying on the back surface side may be performed by a heating roller (a guide roller having a heating mechanism).

Next, the laminate where the layer of the coating liquid for forming the protective organic layer 18 is dried is transported to the curing unit 116. The curing unit 116 performs a curing step of curing the dried layer of the coating liquid. In the organic film forming device 100, the protective organic layer 18 is formed through these steps. In the example shown in the drawing, the curing unit 116 includes an ultraviolet (UV) irradiation device 118 and a backup roll 120.

The curing unit 116 winds the laminate including the support 12, the underlying organic layer 14, the inorganic layer 16, and the dried layer of the coating liquid around the backup roll 120, irradiates the layer of the coating liquid using the UV irradiation device 118 at the position where the laminate is wound around the backup roll 120 to polymerize (crosslink) an organic compound in the layer of the coating liquid. As a result, the protective organic layer 18 is formed. Further, optionally, the curing of the organic compound that forms the protective organic layer 18 may be performed in an inert atmosphere such as a nitrogen atmosphere.

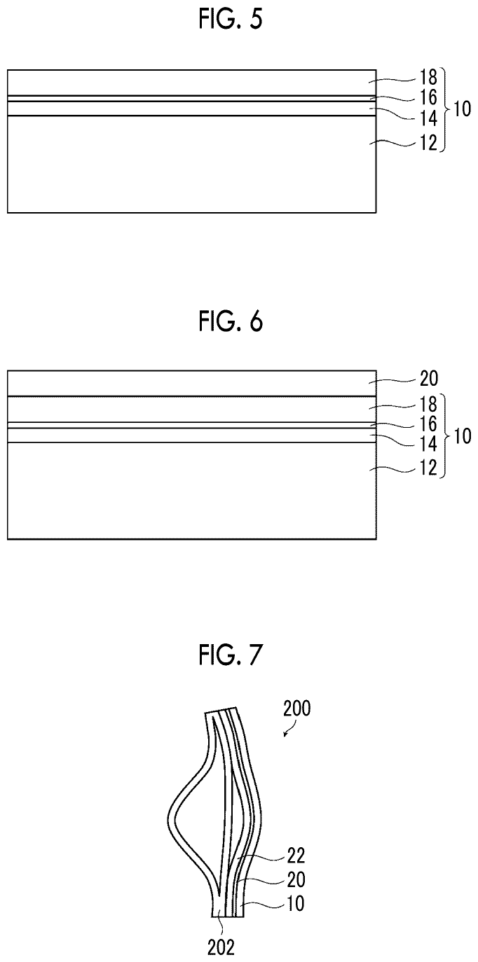

Through the step of forming the protective organic layer 18, the gas barrier film 10 including the support 12, the underlying organic layer 14, the inorganic layer 16, and the protective organic layer 18 in this order is prepared as shown in FIG. 5. The gas barrier film 10 is transported in the predetermined path by the transport rollers 104, and is wound in a roll shape by the winding shaft 122.

In a case where the preparation of the gas barrier film 10 having a predetermined length ends, the gas barrier film 10 is optionally cut and then wound to obtain a roll 10A (winding step). The roll 10A is further supplied to the adhesive layer application step and the sealant layer bonding step.

Here, in the manufacturing method according to the embodiment of the present invention, during the formation of the protective organic layer 18 that is performed in the above-described organic film forming device 100, in the protective organic layer application step performed in the application unit 108, a difference in charge voltage of the surface of the gas barrier film 10 on the inorganic layer 16 side from the surface of the gas barrier film 10 on the support 12 side is 10 kV to 40 kV.

As described above, in a case where a protective organic layer is formed on the inorganic layer, while peeling the pressure-sensitive adhesive film (protective film) from the inorganic layer and applying a coating liquid for forming the protective organic layer to the inorganic layer, attachment of foreign matter (dust) is unavoidable, which causes a problem.

The present inventors conducted an investigation on this point and found the following points. Foreign matter attached to the surface on the inorganic layer side can be embedded in the protective organic layer by applying the coating liquid for forming the protective organic layer, and thus does not cause a problem. However, in a case where the film is wound around a backup roll of the application unit in a state where foreign matter is attached to the surface on the support side, unevenness occurs in the film, which causes a problem of a coating defect such as a non-uniform thickness of the protective organic layer. In addition, in a case where the protective organic layer is formed and wound in a roll shape in a state where foreign matter is attached to the surface on the support side, the surface on the support side comes into contact with the surface on the protective organic layer side. Therefore, the foreign matter is attached to the surface on the protective organic layer side. In a case where an adhesive for bonding the sealant layer is applied in a state where foreign matter is attached to the surface on the protective organic layer side, coating missing starts from the foreign matter, which causes a problem such as insufficient adhesion with the sealant layer.

As a result, gas barrier properties of a packaging material with the gas barrier film decrease, and there is a problem in that the content in the packaging material cannot be protected.

On the other hand, in the manufacturing method according to the embodiment of the present invention, in the protective organic layer application step, a difference in charge voltage of the surface of the gas barrier film 10 on the inorganic layer 16 side from the surface of the gas barrier film 10 on the support 12 side is 10 kV to 40 kV. That is, the charge voltage on the surface on the inorganic layer 16 side to which the coating liquid for forming the protective organic layer 18 is applied is higher than the charge voltage on the surface on the support 12 side. As a result, dust (foreign matter) can be selectively adsorbed on the surface on the inorganic layer 16 side having a higher charge voltage, and the amount of dust attached to the surface on the support 12 side can be reduced. As described above, dust attached to the surface on the inorganic layer 16 side can be embedded in the protective organic layer by applying the coating liquid for forming the protective organic layer, which does not cause a problem. In addition, the amount of dust attached to the surface on the support 12 side can be reduced. Therefore, in a case where the laminate is wound around the backup roll of the application unit, a coating defect caused by unevenness on the film can be prevented. In addition, the amount of dust attached to the surface on the support 12 side can be reduced. Therefore, after forming the protective organic layer 18, even in a case where the surface on the support 12 side and the surface on the protective organic layer 18 side come into contact with each other during the winding in a roll shape, the amount of foreign matter attached to the surface on the protective organic layer 18 side can be reduced. In a case where the adhesive for bonding the sealant layer is applied to the surface of the protective organic layer 18, the occurrence of coating missing can be reduced, and a problem can be prevented.

Accordingly, a decrease in gas barrier properties of a packaging material with the gas barrier film can be prevented, and the content in the packaging material can be reliably protected.

In addition, as the charge voltage on the surface on the inorganic layer 16 side increases, the size of foreign matter to be adsorbed increases. As the size of foreign matter to be adsorbed excessively increases, the foreign matter cannot be completely embedded in the protective organic layer 18, and may protrude from the protective organic layer 18. On the other hand, in the manufacturing method according to the embodiment of the present invention, a difference in charge voltage of the surface of the gas barrier film 10 on the inorganic layer 16 side from the surface of the gas barrier film 10 on the support 12 side is 40 kV or less. As a result, the size of foreign matter to be adsorbed can be appropriately adjusted with respect to the thickness of the protective organic layer 18.

In addition, as in the example shown in FIG. 4, in the transport path from the position where the pressure-sensitive adhesive film 17 is peeled off to the application unit 108, even in a case where the laminate is transported such that the coating surface (surface on the inorganic layer 16 side) during the application faces downward in the vertical direction, dust (foreign matter) can be adsorbed on the surface on the inorganic layer 16 side using the charge voltage.

Here, from the viewpoint that, for example, dust (foreign matter) is adsorbed to the surface on the inorganic layer 16 side to reduce the amount of dust attached to the surface on the support 12 side and cissing of the coating liquid for forming the protective organic layer can be suppressed, the difference between the charge voltage on the surface of the gas barrier film 10 on the inorganic layer 16 side and the charge voltage on the surface of the gas barrier film 10 on the support 12 side is preferably 10 kV to 40 kV and more preferably 20 kV to 30 kV.

The charge voltage can be measured using a commercially available charge meter such as a charge meter SK-050 (manufactured by KEYENCE Corporation).

In addition, in the present invention, a charge voltage measured immediately before the protective organic layer application step is considered the charge voltage in the protective organic layer application step. Specifically, the position immediately before the protective organic layer application step is a range of 5 m or less on the upstream side of the position where the application is performed in the application unit 108 for performing the protective organic layer application step in the transport path in the organic film forming device 100 for forming the protective organic layer 18. That is, in the organic film forming device 100, the charge meter may be provided in the range of 5 m or less on the upstream side of the application unit 108 to measure the charge voltage on the surface on the inorganic layer 16 side and the charge voltage on the surface on the support 12 side.

As a method of adjusting the charge voltage on the surface on the inorganic layer 16 side to be higher than the charge voltage on the surface on the support 12 side, there is a method of causing large peeling charging to occur on the surface on the inorganic layer 16 side in a case where the pressure-sensitive adhesive film 17 is peeled off in the pressure-sensitive adhesive film peeling step that is performed before the protective organic layer application step. Specifically, after forming the inorganic layer 16, by appropriately setting conditions for bonding the pressure-sensitive adhesive film 17, conditions for peeling off the pressure-sensitive adhesive film 17, and the like, the size of peeling charging occurring in a case where the pressure-sensitive adhesive film 17 is peeled off in the pressure-sensitive adhesive film peeling step can be adjusted.

More specifically, by adjusting a peel strength at which the pressure-sensitive adhesive film 17 is peeled off from the inorganic layer 16 in the pressure-sensitive adhesive film peeling step to be higher than an adhesive strength at which the pressure-sensitive adhesive film 17 is bonded to the inorganic layer 16, the size of peeling charging can be increased. As a method of adjusting the peel strength at which the pressure-sensitive adhesive film 17 is peeled off from the inorganic layer 16 in the pressure-sensitive adhesive film peeling step to be higher than the adhesive strength at which the pressure-sensitive adhesive film 17 is bonded to the inorganic layer 16, the following method can be used. By bonding the pressure-sensitive adhesive film 17 immediately after forming the inorganic layer 16 in a vacuum, the adhesive strength between the pressure-sensitive adhesive film 17 and the inorganic layer 16 increases due to surface activity of the inorganic layer 16. Therefore, the peel strength at which the pressure-sensitive adhesive film 17 is peeled off from the inorganic layer 16 can be adjusted to be higher than the adhesive strength (catalog value) of the pressure-sensitive adhesive film 17.

In addition, as other methods of adjusting the peel strength at which the pressure-sensitive adhesive film 17 is peeled off from the inorganic layer 16 in the pressure-sensitive adhesive film peeling step to be higher than the adhesive strength at which the pressure-sensitive adhesive film 17 is bonded to the inorganic layer 16, the following methods can be used. After bonding the pressure-sensitive adhesive film 17 to the inorganic layer 16, the laminate where the pressure-sensitive adhesive film 17 is bonded is pressed in a thickness direction by a nip roller such that contact between the pressure-sensitive adhesive film 17 and the inorganic layer 16 is sufficiently ensured to increase the peel strength. In addition, by heating and softening the pressure-sensitive adhesive film 17 before bonding the pressure-sensitive adhesive film 17 to the inorganic layer 16, the contact area with the inorganic layer 16 is increased to increase the peel strength.

Alternatively, in order to increase the size of peeling charging occurring in a case where the pressure-sensitive adhesive film 17 is peeled off, for example, a speed (transportation speed) at which the pressure-sensitive adhesive film 17 is bonded can be increased. By increasing the speed (transportation speed) at which the pressure-sensitive adhesive film 17 is bonded, a period of time from the formation of the inorganic layer to the bonding is reduced, and the pressure-sensitive adhesive film 17 is bonded in a state where the surface activity of the inorganic layer is higher. As a result, the size of peeling charging can be increased.

The adhesive strength of the pressure-sensitive adhesive film is preferably 0.01 to 0.5 N/25 mm, more preferably 0.02 to 0.3 N/25 mm, and still more preferably 0.03 to 0.1 N/25 mm. On the other hand, the peel strength at which the pressure-sensitive adhesive film is peeled off in the pressure-sensitive adhesive film peeling step is preferably 5 to 30 N/25 mm, more preferably 7 to 25 N/25 mm, and still more preferably 10 to 20 N/25 mm.

In addition, in order to prevent a decrease in charge voltage until the protective organic layer application step after peeling off the pressure-sensitive adhesive film 17 from the inorganic layer 16 in the pressure-sensitive adhesive film peeling step to cause peeling charging to occur such that the charge voltage on the surface on the inorganic layer 16 side increases, the distance from a position where the pressure-sensitive adhesive film peeling step is performed to a position where the protective organic layer application step is performed in the transport path is preferably 5 m or less, more preferably 4.5 m or less, and still more preferably 4 m or less.

In other words, by reducing the distance from the position where the pressure-sensitive adhesive film peeling step is performed to the position where the protective organic layer application step, the difference between the charge voltage on the surface on the inorganic layer 16 side and the charge voltage on the surface on the support 12 side in the protective organic layer application step can be further increased.

On the other hand, in a case where the position where the pressure-sensitive adhesive film peeling step is performed to the position where the protective organic layer application step are excessively close to each other, there is a concern that the coating liquid for forming the protective organic layer 18 cannot be uniformly applied due to the effect of rattling of the film occurring in a case where the pressure-sensitive adhesive film 17 is peeled off. Accordingly, from the viewpoint of uniformly applying the coating liquid for forming the protective organic layer 18, the distance from the position where the pressure-sensitive adhesive film peeling step is performed to the position where the protective organic layer application step is performed in the transport path is preferably 0.5 m or more, more preferably 1 m or more, and still more preferably 1.5 m or more.

Next, the roll 10A where the prepared gas barrier film 10 is wound is supplied to the adhesive layer application step and the sealant layer bonding step.

The adhesive layer application step is a step of feeding the gas barrier film 10 from the roll 10A where the gas barrier film 10 including the underlying organic layer 14, the inorganic layer 16, and the protective organic layer 18 in this order on the support 12 is wound and applying an adhesive for forming an adhesive layer to the protective organic layer 18. Through the adhesive layer application step, a laminate including the underlying organic layer 14, the inorganic layer 16, the protective organic layer 18, and the adhesive layer 20 in this order on the support 12 as shown in FIG. 6 is obtained.

As a method of applying the adhesive in the adhesive layer application step, various well-known methods such as a die coating method, a dip coating method, an air knife coating method, a curtain coating method, a roller coating method, a wire bar coating method, and a gravure coating method can be used.

The sealant layer bonding step is a step of bonding the sealant layer 22 to the adhesive layer 20 formed on the protective organic layer 18 of the gas barrier film 10. A method of bonding the sealant layer 22 is not particularly limited, and a well-known bonding method in the related art can be appropriately used.

By bonding the sealant layer 22 in the sealant layer bonding step, a barrier film for a packaging material including the gas barrier film 10 and the sealant layer 22 bonded to the protective organic layer 18 side of the gas barrier film 10 through the adhesive layer 20 as shown in FIG. 1 is prepared.

Next, a packaging material with a gas barrier film including the above-described barrier film for a packaging material will be described.

FIG. 7 is a diagram conceptually showing an example of the packaging material with a gas barrier film according to the embodiment of the present invention.

A packaging material 200 with a gas barrier film shown in FIG. 7 includes: a packaging material 202; and the sealant layer 22, the adhesive layer 20 and the gas barrier film 10 that are formed on one surface of the packaging material 202. The laminate that is laminated on one surface of the packaging material 202 and includes the sealant layer 22, the adhesive layer 20, and the gas barrier film 10 is the barrier film for a packaging material prepared using the manufacturing method according to the embodiment of the present invention.

In the example shown in FIG. 7, the barrier film for a packaging material is laminated on one surface of the packaging material 202. However, the present invention is not limited to this configuration. The barrier film for a packaging material may be laminated on both surfaces of the packaging material 202. In addition, the barrier film for a packaging material prepared using the manufacturing method according to the embodiment of the present invention may be laminated on one surface of the packaging material 202, and another kind of a barrier film for a packaging material may be laminated on another surface of the packaging material 202.

As shown in FIG. 7, in the packaging material 200 with a gas barrier film, the packaging material 202 and the barrier film for a packaging material are bonded by thermally fusing (heat-sealing) the sealant layer 22. In addition, in the example shown in the drawing, peripheral portions of the packaging material 202 and the barrier film for a packaging material are bonded to form a space therebetween.

### [Packaging Material]

The kind of the packaging material (bag body) 202 is not particularly limited, and is preferably used for packaging a product that requires gas barrier properties. Examples of the product to be packaged include food, non-food, and chemical. The state of the product to be packaged may be liquid, solid, or powdered. It is preferable that, by appropriately performing heat sealing, the packaging material is bag-shaped. Specific examples of the packaging material include a packaging bag for food, a packaging bag for chemical, and an infusion bag.

Specifically, examples of the packaging material 202 include a resin bag obtained by forming a resin film such as a polyethylene resin or a polypropylene resin in a bag shape. Examples of the packaging material 202 include a bag obtained by joining two resin films and a bag obtained by folding and joining one resin film. In the packaging material 202, typically, end parts of the resin film other than a necessary outlet (for example, a liquid discharge port of an infusion bag) may be completely joined.

The thickness of the resin film of the resin bag is preferably 20 to 200 μm.

In the case of the bag obtained by joining two resin films, the two resin films may be films consisting of different materials but are preferably films consisting of the same material.

In a case where the films consisting of the same material are bonded to each other using a heat sealing method, the films can be easily bonded to each other.

### (Infusion Bag)

In a case where the packaging material 202 is an infusion bag, the infusion bag may be a single type including one accommodation chamber where the content is packaged or may be a duplex type including two or more accommodation chambers. Examples of the duplex type include a duplex bag consisting of a powder accommodation chamber and a liquid accommodation chamber that is separated from the liquid accommodation chamber through an easily peelable partition wall. In this case, immediately after use, the partition wall is peeled off to mix powder and liquid, and the mixture is infused from the liquid discharge port. In this case, it is preferable that the method of manufacturing a barrier film for a packaging material according to the embodiment of the present invention is used in the powder accommodation chamber.

Examples of the drug used in the infusion bag include liquid to be administered under the skin or into the blood vessel or abdominal cavity by drip infusion or the like. In the case of the duplex bag, examples of the drug include powdered drug and liquid such as saline. Examples of the powder drug include a nutrient such as vitamin or amino acid, an antibiotic, and an antibacterial agent.

In addition, within a range not departing from the scope of the present invention, techniques described in JP2003-230618A and JP1998-201818A (JPH10-201818A) can be considered.

Hereinbefore, the method of manufacturing a barrier film for a packaging material according to the embodiment of the present invention has been described in detail. However, the present invention is not limited to the above-described aspects and various improvements and changes may be made within a range not departing from the scope of the present invention.

### EXAMPLES

Hereinafter, the present invention will be described in detail using Examples. The present invention is not limited to specific examples described below.

### Example 1

### [Preparation of Gas Barrier Film]

### <Support>

A polyethylene terephthalate film (PET film, manufactured by Toyobo Co., Ltd., trade name: A4300, thickness: 100 μm, width: 1000 mm, length 100 m) was prepared as the support, and an underlying organic layer and an inorganic layer were formed on a single surface side of the PET film in the following procedure.

### <Formation of Underlying Organic Layer>

TMPTA (manufactured by Daicel-Allnex Ltd.) and a photopolymerization initiator (ESACURE KTO 46, manufactured by Lamberti S.p.A.) were prepared and were weighed such that a weight ratio thereof was 95:5. These components were dissolved in methyl ethyl ketone. As a result, a coating liquid (composition for forming an organic layer) having a concentration of solid contents of 15% was obtained. This coating liquid was applied to the above-described PET film through RtoR using a die coater, and the substrate was allowed to pass through a drying zone at 50° C. for 3 minutes. Next, while being heated using a backup roll at 80° C., the coating film was irradiated and cured with ultraviolet rays (cumulative irradiation amount: about 600 mJ/cm²), and the laminate was wound. In this case, before contact with an initial film surface touch roll after the UV curing, a polyethylene protective film was bonded, and then the laminate was wound. The thickness of the underlying organic layer formed on the PET film was 2 μm.

### <Formation of Inorganic Layer>

Using a RtoR CVD device, an inorganic layer (silicon nitride film) was formed on a surface of the underlying organic layer.

Specifically, the wound PET film with the underlying organic layer was fed, the protective film was peeled after passing through a final film surface touch roll before film formation, and the inorganic layer was formed on the exposed resin underlying organic layer. For the formation of the inorganic layer, silane gas (flow rate: 600 sccm), ammonia gas (flow rate: 1500 sccm), and hydrogen gas (flow rate: 2000 sccm) were used as raw material gas. As a power supply, a silicon nitride film was formed using a high frequency power supply having a frequency of 13.56 MHz and a power of 8 kW. The transportation speed was 10 m/min. The film formation pressure was 40 Pa, and the peak film thickness was 30 nm. Before contact with an initial film surface touch roll after the formation of the inorganic layer, a pressure-sensitive adhesive film of polyethylene (PAC-3J-30H, manufactured by Sun A Kaken Co., Ltd.) was bonded, and the laminate was wound to obtain a laminate roll. The adhesive strength (catalog value) of the pressure-sensitive adhesive film was 0.05 N/25 mm.

### <Formation of Protective Organic Layer>

A protective organic layer was formed on the surface of the inorganic layer. As a coating liquid for forming the protective organic layer, a urethane skeleton acrylate polymer (ACRIT 8BR930, manufactured by Taisei Fine Chemical Co., Ltd.), an additive (VYLON U1510, manufactured by Toyobo Co., Ltd.), and a silane coupling agent (KBM5103, manufactured by Shin-Etsu Silicone Co., Ltd.) were mixed at a ratio of 73.25% to 15% to 10%, 1.75% of a photopolymerization initiator (ESCURE KTO46, manufactured by Lamberti S.p.A.) was added, and the components were dissolved in methyl ethyl ketone to prepare a coating liquid having a concentration of solid contents of 15%. Using a roll-to-roll organic film forming device shown in FIG. 4, the film was fed from the laminate roll, the pressure-sensitive adhesive film was peeled off from the inorganic layer through RtoR, the coating liquid was directly applied to the inorganic layer surface using a die coater, and the laminate was allowed to pass through a drying zone at 100° C. for 3 minutes. Next, while being wound around a heating roller heated to 60° C., the coating film was irradiated and cured with ultraviolet rays (cumulative irradiation amount: about 600 mJ/cm²), and the laminate was wound. The thickness of the protective organic layer formed on the inorganic layer was 1 μm. This way, a gas barrier film was prepared.

The pressure-sensitive adhesive film was peeled off at a position that was 3 m upstream of the position where the coating liquid for forming the protective organic layer was applied. In addition, a 180° peel test was performed using a tension tester AGS-X (manufactured by Shimadzu Corporation), and in a case where a peel strength at which the pressure-sensitive adhesive film was peeled off was measured, the peel strength was 12 N/25 mm.

In addition, at a position immediately before the position where the coating liquid for forming the protective organic layer was applied, specifically, at a position that was 500 mm upstream of the position where the coating liquid for forming the protective organic layer was applied, each of a charge voltage on the surface on the inorganic layer side and a charge voltage on the surface on the support side was measured using a charge meter (charge meter SK-050, manufactured by KEYENCE Corporation). The charge voltage on the surface on the inorganic layer side was 27 kV. In addition, the charge voltage on the surface on the support side was 2 kV. Accordingly, a difference between the charge voltages was 25 kV.

The prepared gas barrier film was cut into 100 mm×100 mm, and the water vapor transmission rate was measured using a MOCON method. For the measurement, AQUATRAN 2 (manufactured by Hitachi High-Tech Corporation) was used. The measurement was evaluated at a temperature of 40° C. and a humidity of 90%, and the obtained value was converted into a value at a temperature of 25° C. and a humidity of 50% RH by the Arrhenius plot to derive a water vapor transmission rate at a temperature of 25° C. and a humidity of 50% RH.

As a result of the measurement, the water vapor transmission rate of the gas barrier film was 1×10⁻⁴ g/(m²·day) or less.

### [Preparation of Barrier Film for Packaging Material]

As a sealant layer, a resin film (polypropylene film, manufactured by TORAY INDUSTRIES, INC., thickness: 30 μm, melting point: about 161° C.) was prepared.

The gas barrier film was drawn from the roll, and a polyurethane adhesive (main agent: polyester polyol; RU-77T manufactured by Rock Paint Co., Ltd., curing agent: aliphatic isocyanate; H-7, manufactured by Rock Paint Co., Ltd.) was applied to the protective organic layer side of the gas barrier film to form an adhesive layer. The thickness of the adhesive layer was 3 μm.

Next, the resin film as the sealant layer was bonded to the adhesive layer to prepare a barrier film for a packaging material.

### Examples 2 and 3 and Comparative Examples 1 to 4

A barrier film for a packaging material was prepared using the same method as that of Example 1, except that conditions during the formation of the inorganic layer were changed as shown in Table 1 below. In all of Examples and Comparative Examples, the thickness of the formed inorganic layer was 30 nm.

In addition, the peel strength at which the pressure-sensitive adhesive film was peeled off from the inorganic layer during the formation of the protective organic layer, the charge voltage on the surface on the inorganic layer side and the charge voltage on the surface on the support side during the application of the coating liquid for forming the protective organic layer, and a difference between the charge voltages were measured, and the results are shown in Table 2.

TABLE 1

| | During Formation of Inorganic Layer | | | | |
|---|---|---|---|---|---|
| | Film Forming Conditions | | | | |
| | Transportation | Power | SiH₄ | NH₃ | H₂ |
| | Speed m/min | kW | sccm | sccm | sccm |
| Example 1 | 10 | 8 | 600 | 1500 | 2000 |
| Example 2 | 5 | 4 | 300 | 750 | 1000 |
| Example 3 | 15 | 12 | 900 | 2250 | 3000 |
| Comparative | 4 | 3.2 | 240 | 600 | 1000 |
| Example 1 | | | | | |
| Comparative | 2 | 1.6 | 120 | 300 | 1000 |
| Example 2 | | | | | |
| Comparative | 1 | 0.8 | 60 | 150 | 1000 |
| Example 3 | | | | | |
| Comparative | 20 | 16 | 1200 | 3000 | 4000 |
| Example 4 | | | | | |

### Examples 4 and 5

Barrier films for a packaging material were prepared using the same method as that of Example 1, except that the distances from the position where the pressure-sensitive adhesive film was peeled off to the position where the coating liquid for forming the protective organic layer was applied were 300 mm and 1000 mm, respectively.

The peel strength at which the pressure-sensitive adhesive film was peeled off from the inorganic layer during the formation of the protective organic layer, the charge voltage on the surface on the inorganic layer side and the charge voltage on the surface on the support side during the application of the coating liquid for forming the protective organic layer, and a difference between the charge voltages were measured, and the results are shown in Table 2.

### Example 6

A barrier film for a packaging material was prepared using the same method as that of Example 1, except that, during the formation of the inorganic layer, after bonding the pressure-sensitive adhesive film, nipping was performed under the condition that the entire area of 1000 mm of the pressure-sensitive adhesive film in the width direction was pressed using the next transport roller at a pressing strength of 100 N.

### Example 7

A barrier film for a packaging material was prepared using the same method as that of Example 1, except that, during the formation of the inorganic layer, the pressure-sensitive adhesive film was heated to 50° C. immediately before bonding the pressure-sensitive adhesive film.

### [Evaluation]

In the prepared barrier film for a packaging material, the number of coating missing portions of the adhesive in a range of length 10 m×width 1 m was counted by visual inspection.

The results are shown in Table 2.

TABLE 2

| | | | | | Evaluation |
|---|---|---|---|---|---|
| | During Formation of Protective Organic Layer | | | | Number of |
| | Pressure- | | | | Coating |
| | Sensitive | Amount of Charge | | | Missing |
| | Adhesive Film | Front | Back | | Portions |
| | Peel Strength | Surface | Surface | Difference | Pieces/ |
| | N/25 mm | kV | kV | kV | 1 × 10 m |
| Example 1 | 12 | 27 | 2 | 25 | 0 |
| Example 2 | 7 | 12 | 1 | 11 | 2 |
| Example 3 | 28 | 44 | 5 | 39 | 3 |
| Comparative | 4.5 | 9 | 0.5 | 8.5 | 8 |
| Example 1 | | | | | |
| Comparative | 3 | 3 | 0.2 | 2.8 | 20 |
| Example 2 | | | | | |
| Comparative | 0.8 | 0.5 | 0 | 0.5 | 55 |
| Example 3 | | | | | |
| Comparative | 37 | 50 | 5 | 45 | 7 |
| Example 4 | | | | | |
| Example 4 | 18 | 33 | 4 | 29 | 0 |
| Example 5 | 9 | 14 | 1 | 13 | 1 |
| Example 6 | 17 | 31 | 3 | 28 | 0 |
| Example 7 | 22 | 38 | 5 | 33 | 0 |

It can be seen from Table 2 that, in the barrier film for a packaging material prepared using the method of manufacturing a barrier film for a packaging material according to the embodiment of the present invention, the number of coating missing portions in the adhesive layer was less than that of Comparative Examples.

It can be seen that, in Comparative Examples 1 to 3, during the application of the coating liquid for forming the protective organic layer, the difference between the charge voltage on the surface of the gas barrier film on the inorganic layer side and the charge voltage on the surface of the gas barrier film on the support side was small, and thus the number of coating missing portions was large. In addition, in Comparative Example 4, since the difference between the charge voltages was very large, the size of foreign matter adsorbed on the surface on the inorganic layer side was large, and was not able to be completely embedded in the protective organic layer.

In addition, it can be seen from a comparison between Examples 1 to 7 that, during the application of the coating liquid for forming the protective organic layer, the difference between the charge voltage on the surface of the gas barrier film on the inorganic layer side and the charge voltage on the surface of the gas barrier film on the support side was more preferably 25 to 33 kV.

From the above results, the effects of the present invention are obvious.

### EXPLANATION OF REFERENCES

10: gas barrier film
10A: roll
11: laminate
11A: laminate roll
12: support
14: underlying organic layer
16: inorganic layer
18: protective organic layer
20: adhesive layer
22: sealant layer
100: organic film forming device
102: rotating shaft
104: transport roller
106: winding shaft
108: application unit
110: die coater
112: backup roll
114: drying unit
116: curing unit
118: UV irradiation device
120: backup roll
122: winding shaft
200: packaging material with gas barrier film
202: bag body (packaging material)

What is claimed is:

1. A method of manufacturing a barrier film for a packaging material, the method comprising:
a winding step of winding a gas barrier film including an underlying organic layer, an inorganic layer, and a protective organic layer in this order on a support in a roll shape;
an adhesive layer application step of feeding the gas barrier film from the wound roll and applying an adhesive layer to the protective organic layer; and
a sealant layer bonding step of bonding a sealant layer to the gas barrier film through the adhesive layer,
wherein the method further includes
a pressure-sensitive adhesive film bonding step of bonding pressure-sensitive adhesive film to the inorganic layer after forming the inorganic layer, and
a pressure-sensitive adhesive film peeling step of peeling off the pressure-sensitive adhesive film before a protective organic layer application step of forming the protective organic layer, and
in the protective organic layer application step, a difference between a charge voltage on a surface of the gas barrier film on the inorganic layer side and a charge voltage on a surface of the gas barrier film on the support side is 10 kV to 40 kV.

2. The method of manufacturing a barrier film for a packaging material according to claim 1,
wherein an adhesive strength at which the pressure-sensitive adhesive film is bonded to the inorganic layer is 0.01 to 0.5 N/25 mm, and
a peel strength at which the pressure-sensitive adhesive film is peeled off in the pressure-sensitive adhesive film peeling step is 5 to 30 N/25 mm.

3. The method of manufacturing a barrier film for a packaging material according to claim 1,
wherein another member does not come into contact with a surface of the inorganic layer opposite to the underlying organic layer in a period from an inorganic layer forming step of forming the inorganic layer on the underlying organic layer to the pressure-sensitive adhesive film bonding step.

4. The method of manufacturing a barrier film for a packaging material according to claim 1,
wherein a material of the pressure-sensitive adhesive film is polyethylene or polypropylene.

5. The method of manufacturing a barrier film for a packaging material according to claim 1, wherein a water vapor transmission rate of the barrier film for a packaging material under conditions of a temperature of 25° C. and a relative humidity of 50% RH is 1.0×10⁻⁴ g/(m²·day) or less.

6. The method of manufacturing a barrier film for a packaging material according to claim 1, wherein a density of the inorganic layer is 2.0×10³ kg/m³ or more.

7. The method of manufacturing a barrier film for a packaging material according to claim 2,
wherein another member does not come into contact with a surface of the inorganic layer opposite to the underlying organic layer in a period from an inorganic layer forming step of forming the inorganic layer on the underlying organic layer to the pressure-sensitive adhesive film bonding step.

8. The method of manufacturing a barrier film for a packaging material according to claim 2,
wherein a material of the pressure-sensitive adhesive film is polyethylene or polypropylene.

9. The method of manufacturing a barrier film for a packaging material according to claim 2,
wherein a water vapor transmission rate of the barrier film for a packaging material under conditions of a temperature of 25° C. and a relative humidity of 50% RH is 1.0×10⁻⁴ g/(m²·day) or less.

10. The method of manufacturing a barrier film for a packaging material according to claim 2,
wherein a density of the inorganic layer is 2.0×10³ kg/m³ or more.

11. The method of manufacturing a barrier film for a packaging material according to claim 3,
wherein a material of the pressure-sensitive adhesive film is polyethylene or polypropylene.

12. The method of manufacturing a barrier film for a packaging material according to claim 3,
wherein a water vapor transmission rate of the barrier film for a packaging material under conditions of a temperature of 25° C. and a relative humidity of 50% RH is 1.0×10⁻⁴ g/(m²·day) or less.

13. The method of manufacturing a barrier film for a packaging material according to claim 3,
wherein a density of the inorganic layer is 2.0×10³ kg/m³ or more.

14. The method of manufacturing a barrier film for a packaging material according to claim 4,
wherein a water vapor transmission rate of the barrier film for a packaging material under conditions of a temperature of 25° C. and a relative humidity of 50% RH is 1.0×10⁻⁴ g/(m²·day) or less.

15. The method of manufacturing a barrier film for a packaging material according to claim 4,
wherein a density of the inorganic layer is 2.0×10³ kg/m³ or more.

16. The method of manufacturing a barrier film for a packaging material according to claim 5,
wherein a density of the inorganic layer is 2.0×10³ kg/m³ or more.
